(19) United States
(12) Patent Application Publication
(10) Pub. No.: US 2023/0302959 A1
(43) Pub. Date: Sep. 28, 2023

(54) BATTERY MANAGEMENT SYSTEM AND BATTERY MANAGEMENT METHOD

(71) Applicant: HONDA MOTOR CO., LTD., Tokyo (JP)

(72) Inventors: Hibiki Saeki, Wako-shi (JP); Takahiro Shinke, Wako-shi (JP)

(21) Appl. No.: 18/185,488

(22) Filed: Mar. 17, 2023

(30) Foreign Application Priority Data
Mar. 22, 2022 (JP) 2022-045525

(51) Int. Cl. B60L 58/16; B60L 58/18

(52) U.S. Cl. CPC B60L 58/16; B60L 58/18; B60L 2250/16

(57) ABSTRACT

A battery management system includes: a battery-capacity dividing unit that virtually divides a chargeable capacity of a battery mounted on a mobile object into a first region and a second region to enable a first user to use the first region in the battery and a second user to use the second region in the battery; an amount-of-deterioration-decrease estimation unit that estimates the amount of deterioration decrease that is the amount of decrease in the chargeable capacity of the battery due to deterioration; and an allocation-capacity adjustment unit that, in a case in which the amount of deterioration decrease is lower than or equal to a first specified amount, reduces a chargeable capacity of the second region by the amount of deterioration decrease.

### INCORPORATION BY REFERENCE

The present application claims priority under 35 U.S.C.§119 to Japanese Patent Application No. 2022-045525 filed on Mar. 22, 2022. The content of the application is incorporated herein by reference in its entirety.

### BACKGROUND OF THE INVENTION

### Field of the Invention

The present invention relates to battery management systems and battery management methods.

### Description of the Related Art

Devices have been proposed that manage the capacity of a battery mounted on an electric vehicle by virtually dividing the capacity of the battery into a first region used for transmitting/receiving electric power to/from electric power equipment connected to an electric-power network and a second region used by the vehicle user, and that display the remaining amount of the second region on a meter of the vehicle (for example, see International Publication No. WO 2020/148850).

### SUMMARY OF THE INVENTION

In the case in which the capacity of a battery mounted on a mobile object such as a vehicle is virtually divided into a plurality of regions and shared between the mobile-object user and another user different from the mobile-object user as in the above conventional technique, if the battery deteriorates due to use of the battery by the other user, the chargeable capacity of the region allocated to the mobile-object user decreases, and the travel range of the mobile object decreases, which is an inconvenient situation. Hence, there is a possibility that mobile-object users hesitate to share the battery with another user, and that this prevents the effective use of batteries by sharing.

The present invention has been made in light of such a background, and an object thereof is to provide a battery management system and a battery management method that make it possible to prevent or mitigate the decrease in the travel range of a mobile object that is caused by battery deterioration in the case the battery mounted on the mobile object is shared between the mobile-object user and another user.

A first aspect to achieve the above object is a battery management system including: a battery-capacity dividing unit that virtually divides a chargeable capacity of a battery mounted on a mobile object into a first region and a second region, allocates the first region to a first user who is a user of the mobile object, and allocates the second region to a second user different from the first user, to enable the first user to use the first region in the battery and the second user to use the second region in the battery; an amount-of-deterioration-decrease estimation unit that estimates the amount of deterioration decrease that is the amount of decrease in the chargeable capacity of the battery due to deterioration; and an allocation-capacity adjustment unit that, in a case in which the amount of deterioration decrease is lower than or equal to a first specified amount, reduces a chargeable capacity of the second region by the amount of deterioration decrease.

The above battery management system may further include a display control unit that displays a chargeable capacity of the first region on a display unit provided in the mobile object.

In the above battery management system, in a case in which the amount of deterioration decrease has exceeded the first specified amount, the allocation-capacity adjustment unit may reduce a chargeable capacity of the first region by part or all of an excess of the amount of deterioration decrease over the first specified amount.

The above battery management system may further include a deterioration-decrease notification unit that, in a case in which the amount of deterioration decrease has exceeded a second specified amount, notifies at least one of the first user or the second user.

A second aspect to achieve the above object is a battery management method that is executed by a computer, including: a battery-capacity dividing step of virtually dividing a chargeable capacity of a battery mounted on a mobile object into a first region and a second region, allocating the first region to a first user who is a user of the mobile object, and allocating the second region to a second user different from the first user, to enable the first user to use the first region in the battery and the second user to use the second region in the battery; an amount-of-deterioration-decrease estimation step of estimating the amount of deterioration decrease that is the amount of decrease in the chargeable capacity of the battery due to deterioration; and an allocation-capacity adjustment step of, in a case in which the amount of deterioration decrease is lower than or equal to a first specified amount, reducing a chargeable capacity of the second region by the amount of deterioration decrease.

The above battery management system performs a process of reducing the chargeable capacity allocated to another user different from the user of the mobile object by the amount of deterioration decrease when the chargeable capacity of the battery has decreased due to battery deterioration. This configuration makes it possible to prevent or mitigate the decrease in the travel range of the mobile object that is caused by battery deterioration in the case in which the battery mounted on the mobile object is shared between the mobile-object user and another user.

### BRIEF DESCRIPTION OF THE DRAWINGS

FIG. 1 is an explanatory diagram of a configuration of management of a vehicle battery performed by a battery management system;

FIG. 2 is a configuration diagram of the battery management system;

FIG. 3 is a diagram for explaining how the chargeable capacities of regions in the battery are changed;

FIG. 4 is a diagram for explaining display of the state of charge of a first region allocated to the vehicle user; and

FIG. 5 is a flowchart of a process of adjusting the chargeable capacity of each region, based on the decrease in the chargeable capacity of the battery.

### DETAILED DESCRIPTION OF THE PREFERRED EMBODIMENTS

### 1. Configuration of Vehicle Battery Management by Battery Management System

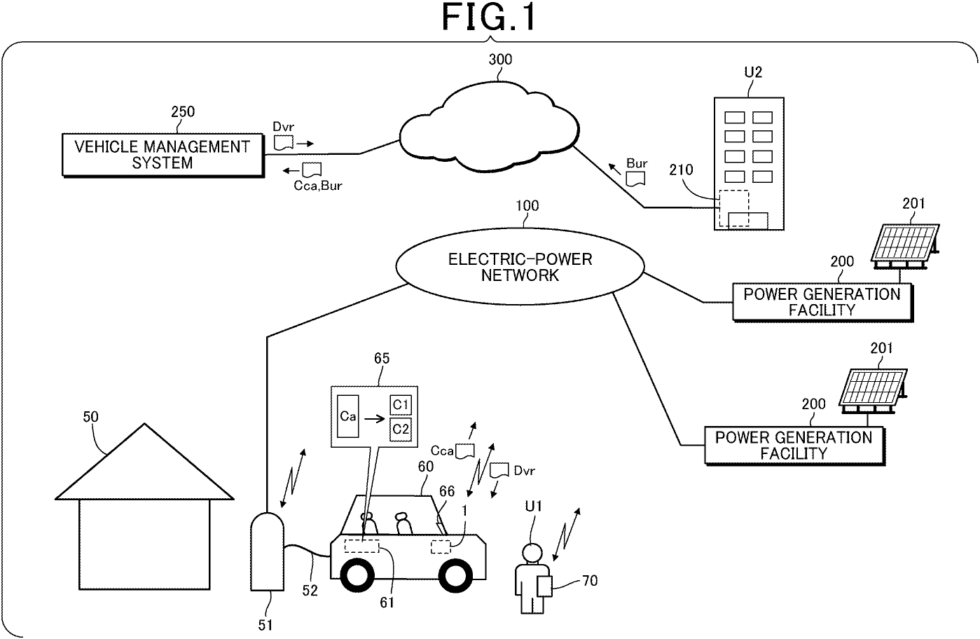

The configuration of management of a battery 61 of a vehicle 60 by a battery management system 1 of the present embodiment will be described with reference to FIG. 1. The battery management system 1 is mounted on the vehicle 60. The battery management system 1 may be mounted as a dedicated device on the vehicle 60 or may be part of the functions of a control device mounted on the vehicle 60.

As the floating box 65 indicates, the battery management system 1 virtually divides the chargeable capacity Ca of the battery 61 mounted on the vehicle 60 into a first region C1 and a second region C2, allocates the first region C1 to a vehicle user U1 and allocates the second region C2 to an electric-power business operator U2. With this configuration, the battery management system 1 enables the vehicle user U1 to use the battery 61 within the range of the first region C1 and the electric-power business operator U2 to use the battery 61 within the range of the second region C2, and this supports effective use of the battery 61.

Here, the first region C1 and the second region C2 are two capacities into which the chargeable capacity Ca of the battery 61 is virtually divided for the vehicle user U1 and the electric-power business operator U2 to share the battery 61, and hence, this does not mean that the plurality of physical cells included in the battery 61 are divided and fixedly allocated to the first region C1 and the second region C2.

The vehicle 60 corresponds to the mobile object of the present disclosure, the vehicle user U1 corresponds to the first user of the present disclosure, and the electric-power business operator U2 corresponds to the second user of the present disclosure. Note that the capacity of the battery 61 may be divided into three or more regions and allocated to the vehicle user U1 and a plurality of electric-power business operators U2.

The vehicle 60 is an electric vehicle (such as an electric automobile or a plug-in hybrid automobile) having the battery 61 as a drive source and is connected to charge/discharge equipment 51 installed at a house building 50, for example, where the vehicle user U1 lives, via a charge/discharge cable 52. The battery 61 is charged via the charge/discharge cable 52 with the electric power supplied from the charge/discharge equipment 51, and the battery 61 also supplies electric power to the charge/discharge equipment 51.

The charge/discharge equipment 51 is connected via an electric-power network 100 to a plurality of power generation facilities 200 operated by the electric-power business operator U2, and the power generation facilities 200 supply generated electric power to the electric-power network 100. Surplus electric generated power is used to charge the battery 61 via the charge/discharge equipment 51, and when the supply of generated electric power to the electric-power network 100 runs short, electric power discharged from the battery 61 is supplied to the electric-power network 100. The power generation facility 200 uses solar panels 201 to generate electric power.

The battery management system 1 communicates with a vehicle management system 250, a management system 210 of the electric-power business operator U2, and the like via a communication network 300. The vehicle management system 250 and the management system 210 are computer systems including processors, memories and communication interfaces. The battery management system 1 communicates with a communication terminal 70 used by the vehicle user U1 and the charge/discharge equipment 51 directly or via the communication network 300. The communication terminal 70 is a smartphone, a mobile phone, a tablet terminal, a laptop personal computer, a desktop personal computer, or the like.

The vehicle management system 250 receives vehicle-state information Cca transmitted from the vehicle 60 and realizes the use state of the vehicle 60 (such as the current position, the travel distance, the travel routes, the number of times the battery 61 has been charged, and the degree of deterioration of the battery 61). The vehicle management system 250 receives battery-use application information Bur for applying for use of the battery 61 transmitted from the management system 210 of the electric-power business operator U2 to receive application for use of the battery 61 from the electric-power business operator U2.

When the vehicle user U1 starts to use the vehicle 60 (for example, when the vehicle user U1 purchases the vehicle 60, or when the vehicle user U1 leases the vehicle 60 and starts to use it), the vehicle management system 250 sets the ratio between the first region C1 and the second region C2 in the battery 61 according to an application or the like made by the vehicle user U1. The vehicle management system 250 transmits ratio instruction information Dvr for giving an instruction to set the ratio between the first region C1 and the second region C2, to the battery management system 1 of the vehicle 60.

The battery management system 1 virtually divides the capacity of the battery 61 into the first region C1 and the second region C2 based on the ratio instruction information Dvr and manages the capacity of the battery 61. The battery management system 1 controls the charge/discharge of the battery 61 such that the first region C1 is allocated for the use by the vehicle user U1 (discharging along with the power consumption by the vehicle 60 and regenerative charging, and charging from the charge/discharge equipment 51 based on the operation by the vehicle user U1), and that the second region C2 is allocated for the use by the electric-power business operator U2 (charging as a buffer of electric power generated by the power generation facilities 200, and discharging to supply electric power to the electric-power network 100).

The battery management system 1 estimates the amount of deterioration decrease which is the amount by which the chargeable capacity has decreased due to deterioration of the battery 61. Then, the battery management system 1 reduces the chargeable capacity of the second region C2 by at least part of the amount of deterioration decrease to adjust the chargeable capacities of the first region C1 and the second region C2. With this configuration, it is possible to prevent or mitigate the decrease in the travel range of the vehicle 60 due to the decrease in the chargeable capacity of the first region C1. The battery management system 1 displays the state of charge of the first region C1 in a display unit 66 provided in the vehicle 60.

Although FIG. 1 shows one electric-power business operator U2 for the convenience of explanation, the configuration may be such that an electric-power business operator U2 to which the second region C2 of the battery 61 is allocated is selected from a plurality of electric-power business operators U2. In this case, the vehicle management system 250 selects an electric-power business operator U2 to which the second region C2 is allocated, based on the use condition of the second region C2 (rental fee, the period of use, or the like) presented by each electric-power business operator U2.

### 2. Configuration of Battery Management System

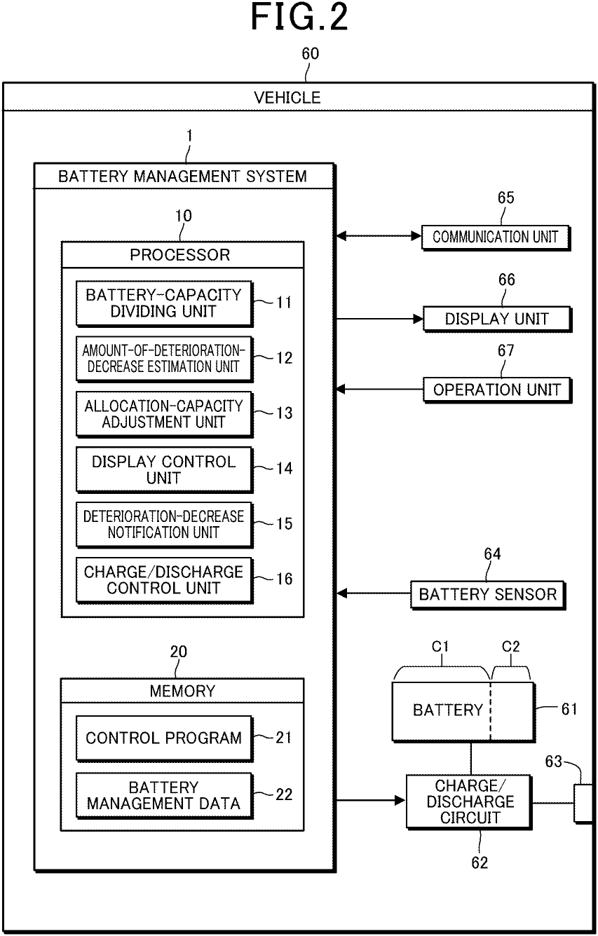

The configuration of the battery management system 1 will be described with reference to FIGS. 2 to 4. With reference to FIG. 2, the vehicle 60 includes the battery management system 1, the battery 61, and the display unit 66 illustrated in FIG. 1 and also a charge/discharge circuit 62, a charge/discharge port 63, a battery sensor 64, a communication unit 65, and an operation unit 67.

The communication unit 65 performs communication with the vehicle management system 250 and the like via the communication network 300 and direct communication with the communication terminal 70 and the like. The operation unit 67 is a touch panel, button switches, or the like and inputs operation signals according to the operation by the vehicle user U1 to the battery management system 1.

The charge/discharge circuit 62 executes charging/discharging of the battery 61 by the charge/discharge equipment 51 (see FIG. 1) connected to the charge/discharge port 63, based on control signals inputted from the battery management system 1. The battery sensor 64 detects the voltage, current, output impedance, temperature, and the like at the time of charging or discharging of the battery 61 and inputs detection signals to the battery management system 1.

In the battery management system 1, a memory 20 stores a control program 21 for the battery management system 1 and battery management data 22 in which information on the chargeable capacities of the first region C1 and the second region C2 of the battery 61 and the like is recorded. A processor 10 reads and executes the control program 21 to function as a battery-capacity dividing unit 11, an amount-of-deterioration-decrease estimation unit 12, an allocation-capacity adjustment unit 13, a display control unit 14, a deterioration-decrease notification unit 15, and a charge/discharge control unit 16.

The process executed by the battery-capacity dividing unit 11 corresponds to the battery-capacity dividing step in the battery management method of the present disclosure, and the process executed by the amount-of-deterioration-decrease estimation unit 12 corresponds to the amount-of-deterioration-decrease estimation step in the battery management method of the present disclosure. The process executed by the allocation-capacity adjustment unit 13 corresponds to the allocation-capacity adjustment step in the battery management method of the present disclosure.

As described above, the battery-capacity dividing unit 11 virtually divides the chargeable capacity Ca of the battery 61 into the first region C1 to be allocated to the vehicle user U1 and the second region C2 to be allocated to the electric-power business operator U2, based on the ratio instruction information Dvr and records information indicating the division ratio in the battery management data 22.

The amount-of-deterioration-decrease estimation unit 12 calculates performance indexes related to the degree of deterioration which is the degree of weariness as compared to the initial performance immediately after the battery 61 was produced, based on the voltage, current, output impedance, temperature, and the like of the battery 61 at the time of charging or discharging that the amount-of-deterioration-decrease estimation unit 12 realized from the detection signals from the battery sensor 64. Then, the amount-of-deterioration-decrease estimation unit 12 estimates the amount of deterioration decrease, which is the amount by which the chargeable capacity of the battery 61 has decreased since the use start time of the vehicle 60, that matches the performance indexes related to the degree of deterioration, based on the performance indexes related to the degree of deterioration. The correspondence relationship between the performance indexes and the amount of deterioration decrease is set based on performance data, experiments, computer simulations, and the like on the battery 61, and the amount-of-deterioration-decrease estimation unit 12 estimates the amount of deterioration decrease in the battery 61 based on this correspondence relationship.

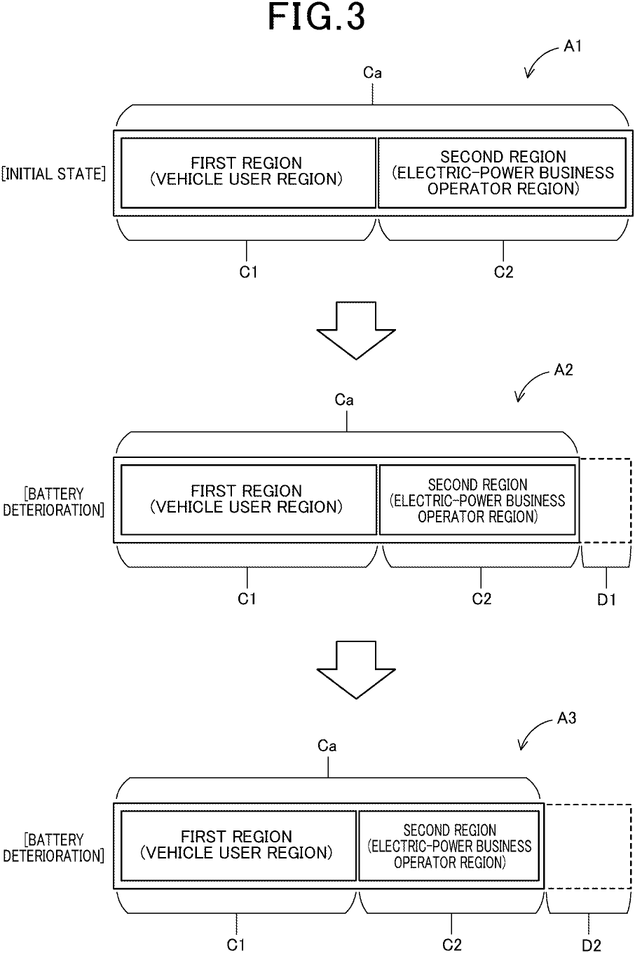

As illustrated in FIG. 3, the allocation-capacity adjustment unit 13 performs a process of reducing the chargeable capacity of the second region C2 allocated to the electric-power business operator U2 or the chargeable capacity of the first region C1 allocated to the vehicle user U1 by the amount of deterioration decrease estimated by the amount-of-deterioration-decrease estimation unit 12. The diagram A1 in FIG. 3 shows the initial state at the time when the vehicle 60 started to be used, and the total chargeable capacity Ca of the battery 61 is virtually divided into the first region C1 and the second region C2.

The diagram A2 shows the battery 61 that has deteriorated since the vehicle 60 started to be used, and the total chargeable capacity Ca of which has decreased by the amount of deterioration decrease D1 which is smaller than or equal to a first specified amount. In this case, the allocation-capacity adjustment unit 13 reduces the chargeable capacity of the second region C2 by the amount of deterioration decrease D1. Because there is no change in the chargeable capacity of the first region C1, the travel range of the vehicle 60 does not decreases.

The diagram A3 shows the battery 61 that has further deteriorated, and the total chargeable capacity Ca of which has decreased by the amount of deterioration decrease D2 which is larger than the first specified amount. In this case, the allocation-capacity adjustment unit 13 reduces the chargeable capacity of the first region C1 by part or all of the excess of the amount of deterioration decrease D2 over the first specified amount and reduces the chargeable capacity of the second region C2 by the rest of the amount of deterioration decrease D2. With this configuration, it is possible to prevent or mitigate an extreme decrease in the chargeable capacity allocated to the electric-power business operator U2 while mitigating the decrease in the travel range of the vehicle 60.

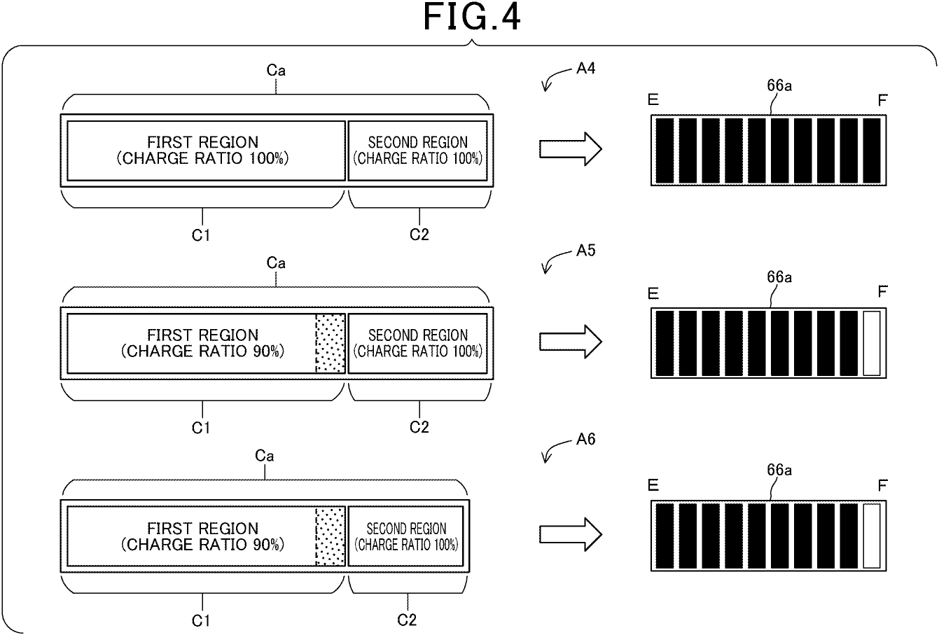

As illustrated in FIG. 4, the display control unit 14 shows a state-of-charge indication 66a for the first region C1 on the display unit 66 of the vehicle 60. The diagram A4 in FIG. 4 shows a case in which both the states of charge of the first region C1 and the second region C2 are 100%. In this case, the display control unit 14 displays 100% (fully charged) in the state-of-charge indication 66a.

The diagram A5 in FIG. 4 show a case in which the state of charge of the first region C1 is 90%, and the state of charge of the second region C2 is 100%. In this case, the display control unit 14 displays 90% in the state-of-charge indication 66a. The diagram A6 in FIG. 4 shows a case in which the total chargeable capacity Ca of the battery 61 has decreased within a range smaller than or equal to the first specified amount, and the chargeable capacity of the second region C2 has decreased. The state of charge of the first region C1 is 90%, and the state of charge of the second region C2 is 100%. In this case, the display control unit 14 displays 90% in the state-of-charge indication 66a.

As illustrated in FIG. 4, the display control unit 14 displays the state-of-charge indication 66a indicating the state of charge of the first region C1 on the display unit 66 without showing the state of charge and the chargeable capacity of the second region C2. This configuration enables the vehicle user U1 to determine the time of charging the vehicle 60 by checking the state-of-charge indication 66a without thinking that the second region C2 is used by the electric-power business operator U2.

When the amount of deterioration decrease estimated by the amount-of-deterioration-decrease estimation unit 12 has exceeded a second specified amount (> the first specified amount), the deterioration-decrease notification unit 15 displays a notification that the chargeable capacity of the battery 61 has decreased on the display unit 66 of the vehicle 60. This makes it possible to urge the vehicle user U1, for example, to do maintenance such as replacing the battery 61 or to replace the vehicle 60. The deterioration-decrease notification unit 15 may transmit information indicating that the amount of decrease in the chargeable amount of the battery 61 has become large, to the communication terminal 70 used by the vehicle user U1 and the management system 210 of the electric-power business operator U2 to notify the vehicle user U1 and the electric-power business operator U2 that the chargeable capacity of the battery 61 has decreased.

The charge/discharge control unit 16 controls the charge/discharge circuit 62 charging and discharging the battery 61 which is virtually divided by the battery-capacity dividing unit 11 into the first region C1 and the second region C2 the chargeable capacities of which are reduced by the allocation-capacity adjustment unit 13.

### 3. Process of Adjusting Chargeable Capacity of Each Region

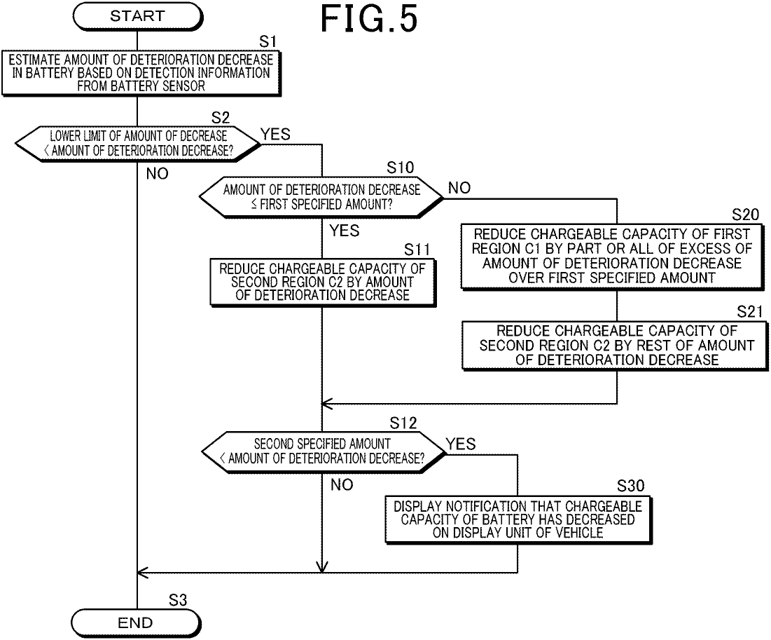

A procedure for adjusting the chargeable capacities of the first region C1 and the second region C2 of the battery 61, executed by the battery management system 1 in the situation illustrated in FIG. 1 will be described based on the flowchart shown in FIG. 5. The battery management system 1 repeatedly executes the process according to the flowchart shown illustrated in FIG. 5.

In step S1 in FIG. 5, the amount-of-deterioration-decrease estimation unit 12 estimates the amount of deterioration decrease in the battery 61 based on detection information from the battery sensor 64. In the following step S2, the allocation-capacity adjustment unit 13 determines whether the amount of deterioration decrease has exceeded a lower limit of the amount of decrease. The lower limit of the amount of decrease is the amount of deterioration decrease at which an adjustment of the chargeable capacities of the first region C1 and the second region C2 is assumed to be necessary, and for example, the lower limit of the amount of decrease is set to 5% or so of the initial total chargeable capacity Ca (at the time when the vehicle 60 started to be used) of the battery 61.

If the amount of deterioration decrease has exceeded the lower limit of the amount of decrease, the allocation-capacity adjustment unit 13 advances the process to step S10, and if the amount of deterioration decrease is lower than or equal to the lower limit of the amount of decrease, the allocation-capacity adjustment unit 13 advances the process to step S3. In step S10, the allocation-capacity adjustment unit 13 determines whether the amount of deterioration decrease is lower than or equal to the first specified amount. Then, if the amount of deterioration decrease is lower than or equal to the first specified amount, the allocation-capacity adjustment unit 13 advances the process to step S11, and if the amount of deterioration decrease has exceeded the first specified amount, the allocation-capacity adjustment unit 13 advances the process to step S20.

In step S11, as described above with reference to the diagram A2 in FIG. 3, the allocation-capacity adjustment unit 13 reduces the chargeable capacity of the second region C2 of the battery 61 by the amount of deterioration decrease D1 and advances the process to step S12. In steps S20 and S21, as described above with reference to the diagram A3 in FIG. 3, the allocation-capacity adjustment unit 13 reduces the chargeable capacity of the first region C1 by part or all of the excess of the amount of deterioration decrease D2 over the first specified amount, reduces the chargeable capacity of the second region C2 by the rest of the amount of deterioration decrease D2, and advances the process to step S12.

In step S12, the deterioration-decrease notification unit 15 determines whether the amount of deterioration decrease has exceeded the second specified amount (> the first specified amount). Then, if the amount of deterioration decrease has exceeded the second specified amount, the deterioration-decrease notification unit 15 advances the process to step S30, and if the amount of deterioration decrease is lower than or equal to the second specified amount, the deterioration-decrease notification unit 15 advances the process to step S3. In step S30, the deterioration-decrease notification unit 15 displays a notification that the chargeable capacity of the battery 61 has decreased, on the display unit 66 of the vehicle 60.

### 4. Other Embodiments

Although the mobile object of the present disclosure is the vehicle 60 in the above embodiment, the mobile object of the present disclosure only has to be one including a battery charged and discharged by charge/discharge equipment and hence may be an aircraft, a ship, or the like.

Although the above embodiment includes the deterioration-decrease notification unit 15, and when the amount of deterioration decrease in the battery 61 has exceeded the second specified amount, the deterioration-decrease notification unit 15 notifies at least one of the vehicle user U1 or the electric-power business operator U2, the configuration without a deterioration-decrease notification unit 15 is possible.

The above embodiment described a configuration in which the vehicle 60 is equipped with the battery management system 1 of the present disclosure. However, as another embodiment, part or all of the battery management system 1 may be included in the vehicle management system 250. For example, in the case in which the amount-of-deterioration-decrease estimation unit 12 and the allocation-capacity adjustment unit 13 are included in the vehicle management system 250, the amount-of-deterioration-decrease estimation unit 12 estimates the amount of deterioration decrease in the battery 61 based on the vehicle-state information Cca (see FIG. 1) transmitted from the vehicle 60 to the vehicle management system 250. Then, the allocation-capacity adjustment unit 13 determines the amount to be reduced from the chargeable capacities of the first region C1 and the second region C2 the battery 61, and the vehicle management system 250 transmits information to the vehicle 60 to give an instruction to reduce the chargeable capacities of the first region C1 and the second region C2, so that a control device of the vehicle 60 updates management information on the chargeable capacities of the first region C1 and the second region C2.

Note that FIG. 2 is a schematic diagram illustrating the functional configuration of the battery management system 1 which is divided in terms of main processes to make it easy to understand the invention of the present application, and hence, the configuration of the battery management system 1 may be divided in a different way. The process of each constituent may be executed by one hardware unit or may be executed by a plurality of hardware units. The process illustrated in FIG. 5 performed by the constituents may be executed by one program or a plurality of programs.

### 5. Configurations Supported by Above Embodiment

The above embodiment is a specific example of the following configurations.

(Configuration 1) A battery management system including: a battery-capacity dividing unit that virtually divides a chargeable capacity of a battery mounted on a mobile object into a first region and a second region, allocates the first region to a first user who is a user of the mobile object, and allocates the second region to a second user different from the first user, to enable the first user to use the first region in the battery and the second user to use the second region in the battery; an amount-of-deterioration-decrease estimation unit that estimates the amount of deterioration decrease that is the amount of decrease in the chargeable capacity of the battery due to deterioration; and an allocation-capacity adjustment unit that, in a case in which the amount of deterioration decrease is lower than or equal to a first specified amount, reduces a chargeable capacity of the second region by the amount of deterioration decrease.

The battery management system of Configuration 1 performs a process of reducing the chargeable capacity allocated to another user different from the user of the mobile object by the amount of deterioration decrease when the chargeable capacity of the battery has decreased due to battery deterioration. This configuration makes it possible to prevent or mitigate the decrease in the travel range of the mobile object that is caused by battery deterioration in the case in which the battery mounted on the mobile object is shared between the mobile-object user and another user.

(Configuration 2) The battery management system according to Configuration 1, further including a display control unit that displays a chargeable capacity of the first region on a display unit provided in the mobile object.

The battery management system according to Configuration 2 enables the first user who uses the mobile object to realize the use state of the first region allocated to the first user without thinking about the use state of the second region allocated to the second user.

(Configuration 3) The battery management system according to Configuration 1 or 2, in which in a case in which the amount of deterioration decrease has exceeded the first specified amount, the allocation-capacity adjustment unit reduces a chargeable capacity of the first region by part or all of an excess of the amount of deterioration decrease over the first specified amount.

Since in the case in which the battery deterioration progresses, and the amount of deterioration decrease has exceeded the first specified amount, the battery management system of Configuration 3 reduces the chargeable capacity of the first region by part or all of the excess of the amount of deterioration decrease over the first specified amount, it is possible to prevent or mitigate an extreme decrease in the chargeable capacity allocated to the second user while mitigating the decrease in the travel range of the mobile object.

(Configuration 4) The battery management system according to any one of Configurations 1 to 3, further including a deterioration-decrease notification unit that, in a case in which the amount of deterioration decrease has exceeded a second specified amount, notifies at least one of the first user or the second user.

Since the battery management system of Configuration 4 makes a notification that the chargeable capacity of the battery has decreased, it is possible to urge the first user, for example, to do maintenance such as replacing the battery or to replace the mobile object. It is also possible to urge the second user, for example, to change the mobile object the battery of which the second user uses.

(Configuration 5) A battery management method that is executed by a computer, including: a battery-capacity dividing step of virtually dividing a chargeable capacity of a battery mounted on a mobile object into a first region and a second region, allocating the first region to a first user who is a user of the mobile object, and allocating the second region to a second user different from the first user, to enable the first user to use the first region in the battery and the second user to use the second region in the battery; an amount-of-deterioration-decrease estimation step of estimating the amount of deterioration decrease that is the amount of decrease in the chargeable capacity of the battery due to deterioration; and an allocation-capacity adjustment step of, in a case in which the amount of deterioration decrease is lower than or equal to a first specified amount, reducing a chargeable capacity of the second region by the amount of deterioration decrease.

A computer executing the battery management method of Configuration 5 provides the operational advantage the same as or similar to that of the battery management system of Configuration 1.

REFERENCE SIGNS LIST

| | |
|---|---|
| 1 | battery management system |
| 10 | processor |
| 11 | battery-capacity dividing unit |
| 12 | amount-of-deterioration-decrease estimation unit |
| 13 | allocation-capacity adjustment unit |
| 14 | display control unit |
| 15 | deterioration-decrease notification unit |
| 16 | charge/discharge control unit |
| 20 | memory |
| 21 | control program |
| 22 | battery management data |
| 50 | house building |
| 51 | charge/discharge equipment |
| 52 | charge/discharge cable |
| 60 | vehicle |
| 61 | battery |
| 62 | charge/discharge circuit |
| 63 | charge/discharge port |
| 64 | battery sensor |
| 65 | communication unit |
| 66 | display unit |
| 67 | operation unit |
| 100 | electric-power network |
| 200 | power generation facility |
| 201 | solar panel |
| 210 | management system of electric-power business operator |
| 250 | vehicle management system |
| 300 | communication network |
| U1 | vehicle user (first user) |
| U2 | electric-power business operator (second user) |
| C1 | first region |
| C2 | second region |

What is claimed is:

1. A battery management system comprising:
a battery-capacity dividing unit that virtually divides a chargeable capacity of a battery mounted on a mobile object into a first region and a second region, allocates the first region to a first user who is a user of the mobile object, and allocates the second region to a second user different from the first user, to enable the first user to use the first region in the battery and the second user to use the second region in the battery;
an amount-of-deterioration-decrease estimation unit that estimates the amount of deterioration decrease that is the amount of decrease in the chargeable capacity of the battery due to deterioration; and
an allocation-capacity adjustment unit that, in a case in which the amount of deterioration decrease is lower than or equal to a first specified amount, reduces a chargeable capacity of the second region by the amount of deterioration decrease.

2. The battery management system according to claim 1, further comprising
a display control unit that displays a chargeable capacity of the first region on a display unit provided in the mobile object.

3. The battery management system according to claim 1, wherein
in a case in which the amount of deterioration decrease has exceeded the first specified amount, the allocation-capacity adjustment unit reduces a chargeable capacity of the first region by part or all of an excess of the amount of deterioration decrease over the first specified amount.

4. The battery management system according to claim 1, further comprising
a deterioration-decrease notification unit that, in a case in which the amount of deterioration decrease has exceeded a second specified amount, notifies at least one of the first user or the second user.

5. A battery management method that is executed by a computer, comprising:
a battery-capacity dividing step of virtually dividing a chargeable capacity of a battery mounted on a mobile object into a first region and a second region, allocating the first region to a first user who is a user of the mobile object, and allocating the second region to a second user different from the first user, to enable the first user to use the first region in the battery and the second user to use the second region in the battery;
an amount-of-deterioration-decrease estimation step of estimating the amount of deterioration decrease that is the amount of decrease in the chargeable capacity of the battery due to deterioration; and
an allocation-capacity adjustment step of, in a case in which the amount of deterioration decrease is lower than or equal to a first specified amount, reducing a chargeable capacity of the second region by the amount of deterioration decrease.
